(19) United States
(12) Patent Application Publication
(10) Pub. No.: US 2026/0268179 A1
(43) Pub. Date: Sep. 10, 2026

(54) TOKEN GENERATION METHOD, COMPUTER DEVICE, AND STORAGE MEDIUM

(71) Applicant: Lenovo (Beijing) Limited, Beijing (CN)

(72) Inventor: Ziqi CHEN, Beijing (CN)

(21) Appl. No.: 19/554,061

(22) Filed: Mar. 2, 2026

(30) Foreign Application Priority Data
Mar. 5, 2025 (CN) 202510258871.1

(51) Int. Cl. G06N 5/04; G06N 7/01

(52) U.S. Cl. CPC G06N 5/04; G06N 7/01

(57) ABSTRACT

Token generation method and device are provided. The method includes obtaining input information for a current inference stage of a target model, the input information including first tokens and second tokens, the first tokens including target tokens output from a previous inference stage, and the second tokens including guessing tokens output from the previous inference stage; generating, based on inference performed by the target model, candidate weights for the first tokens and the second tokens, the candidate weights indicating likelihoods that candidate tokens are to be selected as target tokens; and decoding the candidate weights for the first tokens using a first decoding algorithm to generate first target tokens and decoding the candidate weights for the second tokens using a second decoding algorithm to generate second target tokens, and the first decoding algorithm being different from the second decoding algorithm.

### CROSS-REFERENCE TO RELATED APPLICATION

This application claims priority of Chinese Patent Application No. 2025102588711, filed on Mar. 5, 2025, the entire contents of which are hereby incorporated by reference.

### FIELD OF THE DISCLOSURE

The present disclosure generally relates to the field of model inference technology and, more particularly, relates to a token generation method and a token generation device.

### BACKGROUND

In related techniques, during a decoding process of an accelerated model inference method, additional tokens are decoded. Because a random number generator is deterministic, changes to a random-sampling sequence used to decode correct tokens can cause differences between outputs of an accelerated model inference method and outputs of a traditional inference method, thereby reducing model inference accuracy.

### BRIEF SUMMARY OF THE DISCLOSURE

One aspect of the present disclosure provides a token generation method. The method includes obtaining input information for a current inference stage of a target model, the input information including first tokens and second tokens, the first tokens including target tokens output from a previous inference stage, and the second tokens including guessing tokens output from the previous inference stage; generating, based on inference performed by the target model, candidate weights for the first tokens and the second tokens, the candidate weights indicating likelihoods that candidate tokens are to be selected as target tokens; and decoding the candidate weights for the first tokens using a first decoding algorithm to generate first target tokens and decoding the candidate weights for the second tokens using a second decoding algorithm to generate second target tokens, and the first decoding algorithm being different from the second decoding algorithm.

Another aspect of the present disclosure provides a computer device including one or more processors and a memory containing computer programs that, when being executed, cause the one or more processors, to perform some or all of following steps: obtaining input information for a current inference stage of a target model, the input information including first tokens and second tokens, the first tokens including target tokens output from a previous inference stage, and the second tokens including guessing tokens output from the previous inference stage; generating, based on inference performed by the target model, candidate weights for the first tokens and the second tokens, the candidate weights indicating likelihoods that candidate tokens are to be selected as target tokens; and decoding the candidate weights for the first tokens using a first decoding algorithm to generate first target tokens and decoding the candidate weights for the second tokens using a second decoding algorithm to generate second target tokens, and the first decoding algorithm being different from the second decoding algorithm.

Another aspect of the present disclosure provides a non-transitory computer-readable storage medium containing computer programs that, when being executed, cause at least one processor to perform some or all of following steps: obtaining input information for a current inference stage of a target model, the input information including first tokens and second tokens, the first tokens including target tokens output from a previous inference stage, and the second tokens including guessing tokens output from the previous inference stage; generating, based on inference performed by the target model, candidate weights for the first tokens and the second tokens, the candidate weights indicating likelihoods that candidate tokens are to be selected as target tokens; and decoding the candidate weights for the first tokens using a first decoding algorithm to generate first target tokens and decoding the candidate weights for the second tokens using a second decoding algorithm to generate second target tokens, and the first decoding algorithm being different from the second decoding algorithm. The computer-readable storage medium may be transient or non-transient.

Other aspects of the present disclosure can be understood by a person skilled in the art in light of the description, the claims, and the drawings of the present disclosure.

### BRIEF DESCRIPTION OF THE DRAWINGS

Accompanying drawings are incorporated herein and form a part of the present specification. The accompanying drawings illustrate embodiments of the present disclosure and, together with the present specification, serve to explain technical solutions of the present disclosure.

FIG. 1 illustrates a flowchart of a token generation method consistent with various embodiments of the present disclosure;

FIG. 2 illustrates a flowchart of another token generation method consistent with various embodiments of the present disclosure;

FIG. 3 illustrates a flowchart of another token generation method consistent with various embodiments of the present disclosure;

FIG. 4 illustrates a flowchart of another token generation method consistent with various embodiments of the present disclosure;

FIG. 5 illustrates a flowchart of another token generation method consistent with various embodiments of the present disclosure;

FIG. 6 illustrates a flowchart of another token generation method consistent with various embodiments of the present disclosure;

FIG. 7 illustrates a flowchart of another token generation method consistent with various embodiments of the present disclosure;

FIG. 8 illustrates a schematic diagram of an inference process consistent with various embodiments of the present disclosure;

FIG. 9 illustrates a schematic diagram of another inference process consistent with various embodiments of the present disclosure;

FIG. 10 illustrates a schematic diagram of a decoding process consistent with various embodiments of the present disclosure;

FIG. 11 illustrates a schematic diagram of another inference process consistent with various embodiments of the present disclosure;

FIG. 12 illustrates a flowchart of another token generation method consistent with various embodiments of the present disclosure;

FIG. 13 illustrates a schematic diagram of a token generation device consistent with various embodiments of the present disclosure; and

FIG. 14 illustrates a schematic diagram of hardware components of a computer device consistent with various embodiments of the present disclosure.

### DETAILED DESCRIPTION

To make objectives, technical solutions, and advantages of the present disclosure more readily understood, the technical solutions of the present disclosure are further described in detail below with reference to the accompanying drawings and embodiments. The embodiments described herein should not be construed as limiting the present disclosure. All other embodiments obtained by a person skilled in the art without creative efforts shall fall within the protection scope of the present disclosure.

In the following description, reference is made to “some embodiments”, which describe a subset of all possible embodiments. It should be understood that “some embodiments” may be a same subset or different subsets of all possible embodiments and may be combined with one another without conflict. Terms “first”, “second”, and “third” are used merely to distinguish between similar elements and do not indicate any particular order of the elements. Where appropriate, the terms “first”, “second”, and “third” may be interchanged such that the embodiments described herein may be implemented in a specific order or sequence other than an order illustrated or described herein.

Unless otherwise specified, all technical and scientific terms used in the present disclosure have same meanings as commonly understood by a person skilled in the art to which the present disclosure pertains. The terms used herein are for a purpose of describing the present disclosure only and are not intended to limit the present disclosure.

In conventional large language model inference, tokens are generated one by one, resulting in relatively slow token generation. On edge devices with limited computing resources, the resulting latency can adversely affect a user experience.

In the related art, various approaches have been proposed to accelerate an inference process. A commonly used approach accelerates large-model inference computation using lookahead prediction. However, during accelerated model inference, a decoding process decodes additional tokens, and because a random number generator is deterministic, changes to a random-sampling sequence used to decode correct tokens can cause differences between outputs of an accelerated model inference method and outputs of a traditional inference method, thereby reducing model inference accuracy.

In one embodiment, a token generation method executable by a processor of a computer device is provided. The computer device may refer to a server, a laptop computer, a tablet computer, a desktop computer, a smart TV, a set-top box, a mobile device (e.g., a mobile phone, a portable video player, a personal digital assistant (PDA), a dedicated messaging device, or a portable gaming device), or any other device with data processing capabilities.

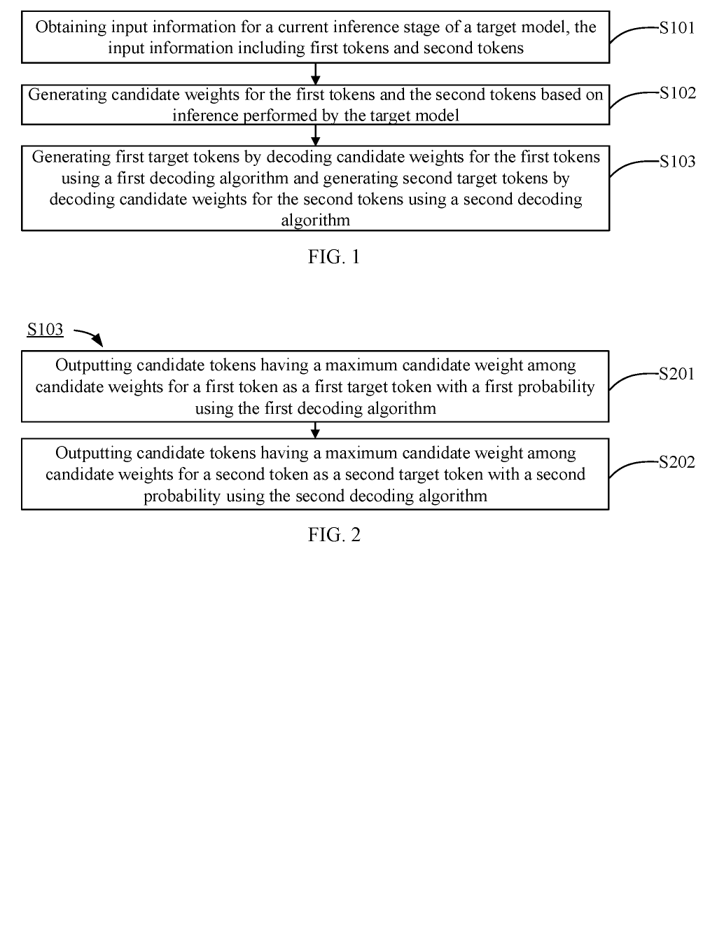

FIG. 1 illustrates a flowchart of a token generation method consistent with various embodiments of the present disclosure. The method may be performed by a processors of a computer device. As shown in FIG. 1, the method includes steps S101–S103, which are described below with reference to FIG. 1.

S101: obtaining input information for a current inference stage of a target model, the input information including first tokens and second tokens.

The first tokens include target tokens output from a previous inference stage. The second tokens include guessing tokens output from a previous inference stage.

In one embodiment, the target model may be a pre-trained large language model configured to perform translation, summarization, prediction, text generation, and the like based on text data, speech data, and other data input by a user. The large language model may include a convolutional neural network model (CNN), a recurrent neural network model (RNN), a self-attention-based neural network model, or the like.

In one embodiment, the target model may include a plurality of inference stages when performing an inference task. For example, a first inference stage performs inference based on user input; a second inference stage performs inference using a next input generated based on output data of the first inference stage; and subsequent inference stages perform inference using respective next inputs generated based on output data of a preceding inference stage, until a final inference stage outputs data that meets preset requirements.

In one embodiment, the input information can include a plurality of tokens, images and the like. During an internal inference stage of the target model, the input information is typically converted into formats that a machine can recognize and process, such as a numerical sequence and vector.

In one embodiment, the input information for a current inference stage is generated based on output data of a previous inference stage. The input information includes at least one first token and at least one second token. The first tokens are correct and acceptable tokens output from a previous inference stage, and the second token are guessing tokens based on the acceptable token output from the previous inference stage and an initial user input.

For example, when the target tokens output from a previous inference stage include “a” and “great”, and a user’s initial input tokens include “It” and “is”, a prediction is performed based on “It”, “is”, “a”, and “great” to obtain guessing tokens including “who”, “is”, and “a”. Therefore, the input information for a current inference stage includes the user's initial input "It" and "is", the target tokens "a" and "great" output from the previous inference stage and the guessing tokens "who", "is", and "a".

S102: generating candidate weights for the first tokens and the second tokens based on inference performed by the target model.

The candidate weights represent respective probabilities that corresponding candidate tokens will be selected as target tokens.

In one embodiment, a target token represents a correct token output by the target model, i.e., a token generated by the target model based on correct input. For example, if the target model generates a token C based on user input tokens A and B, then token C is a correct token. Similarly, if the target model generates a token D based on input tokens A, B, and C, then token D is also a correct token. If the input information includes tokens A, B, C, and D, where A and B are user-input tokens, C is a correct token inferred from tokens A, B, and C and is referred to as a target token, and D is a guessing token inferred from tokens A, B, and C.

If inference based on A, B, and C yields token X and inference based on tokens A, B, C, and D yields token E, and if token X is the same as token D, token D is confirmed as a correct token and token E obtained based on to kens A, B, C, and D is also a correct token. Accordingly, both tokens D” and E may be referred to as target tokens.

In one embodiment, a candidate weight table for the first tokens represents a probability distribution of next tokens generated by the target model after performing inference using the first tokens as input tokens.

Based on a preset vocabulary, the target model predicts next tokens of the first tokens, thereby generating a probability distribution for at least one predicted next token of the first tokens.

For example, the first tokens are "It”, "is”, "a”, "great”. Based on a contextual relationship of the first tokens, the target model determines, from the vocabulary, that a next token after “It”, “is”, “a”, and “great” may be “who”, “is”, or “a”. Respective probabilities of “who”, “is”, and “a” being the next token are 0.5, 0.2, and 0.3. Accordingly, candidate weights for the next token are 0.5, 0.2, and 0.3.

In one embodiment, a candidate weight table for the second tokens represents a probability distribution of next tokens of the second tokens, generated by the target model based on inference using the first tokens, the second tokens, and the vocabulary.

For example, the first tokens include "It", "is", "a", "great" and the second tokens include "who", "is", "a". Based on a contextual relationship between the first tokens and the second tokens, the target model retrieves, from a vocabulary list, candidate next tokens of "who" in the second tokens, including "is", "the", and "he", with respective probabilities 0.2, 0.4, and 0.4 of being target tokens. For the token “is” in the second tokens, candidate next tokens include “just”, “a”, and “great”, with respective probabilities 0.3, 0.4, and 0.3 of being target tokens. For the token “a” in the second tokens, candidate next tokens include “just”, “best”, and “intent”, with respective probabilities 0.1, 0.4, and 0.4 of being target tokens. Accordingly, for “who”, the candidate tokens “is”, “the”, and “he” have candidate weights 0.2, 0.4, and 0.4; for “is”, the candidate tokens “just”, “a”, and “great” have candidate weights 0.3, 0.4, and 0.3; and for “a”, the candidate tokens “just”, “best”, and “intent” have candidate weights 0.1, 0.4, and 0.4.

S103: generating first target tokens by decoding candidate weights for the first tokens using a first decoding algorithm and generating second target tokens by decoding candidate weights for the second tokens using a second decoding algorithm.

The first decoding algorithm is different from the second decoding algorithm.

In one embodiment, the first decoding algorithm and the second decoding algorithm differ in how each algorithm utilizes candidate tokens having a maximum candidate weight among the candidate weights.

In one embodiment, the candidate weights form a probability distribution representing likelihoods of candidate tokens being a next token.

For example, candidate tokens for a first token include tokens A, B, C, and D with respective probabilities 0.2, 0.3, 0.15, and 0.35, and candidate tokens for a second token include tokens E, F, and G with respective probabilities 0.35, 0.45, and 0.2.

In one embodiment, the first decoding algorithm may be a weighted random sampling algorithm, a greedy selection algorithm, or the like, and the second decoding algorithm may be a weighted random sampling algorithm, a greedy selection algorithm, or the like. A probability utilization method of the weighted random sampling algorithm differs from a probability utilization method of the greedy selection algorithm. If the first decoding algorithm is a weighted random sampling algorithm, the second decoding algorithm is a greedy selection algorithm. If the first decoding algorithm is a greedy selection algorithm, the second algorithm is a weighted random sampling algorithm. In other words, the first and second decoding algorithms differ in how probabilities are utilized during decoding.

In one embodiment, using the first decoding algorithm, candidate tokens having respective probabilities greater than K are identified from a probability distribution of candidate tokens for a first token, and a first target token is randomly selected from the identified candidate tokens.

For example, candidate tokens for a first token include tokens A, B, C, and D with respective probabilities 0.2, 0.3, 0.15, and 0.35. If K is 0.3, the tokens B and D have probabilities greater than or equal to K. The first target token is randomly selected from tokens B and D, for example resulting in the token B being selected.

In one embodiment, using the second decoding algorithm, a candidate token having a highest probability in a probability distribution of candidate tokens for a second token is selected as the second target token.

For example, candidate tokens for a second token include tokens E, F, and G with respective probabilities 0.35, 0.45, and 0.2. The candidate token having the highest probability, token F, is selected as the second target token.

In one embodiment, during a target model inference process, input information for a current inference stage is obtained. Based on the input information, candidate weights for the first token and the second token are obtained. For the first token, which represents a target token output by a previous inference stage, the candidate weights for the first token are decoded using a first decoding algorithm to generate a first target token. For the second token, which is a guessing token output by the previous inference stage, the candidate weights for the second token are decoded using a second decoding algorithm to generate the second target token. Because the input information includes not only target tokens output by a previous stage but also guessing tokens, decoding both the target tokens and the guessing tokens to obtain additional second target tokens can improve model inference speed. Further, because the first decoding algorithm for target tokens and the second decoding algorithm for the guessing tokens utilize probability weights in different manners, decoding of the guessing tokens may not affect decoding of the target tokens, thereby improving accuracy during accelerated decoding.

FIG. 2 illustrates a flowchart of another token generation method consistent with various embodiments of the present disclosure. The method can be executed by a processor of a computer device. Referring to FIG. 1, step S103 shown in FIG. 1 may be updated to include steps S201 and S202, which are described below with reference to FIG. 2.

S201: outputting candidate tokens having a maximum candidate weight among candidate weights for a first token as a first target token with a first probability using the first decoding algorithm.

In one embodiment, a maximum candidate weight among candidate weights for a first token represents a highest probability in a probability distribution of a plurality of candidate tokens for the first token. The first probability is determined based on a probability of most-likely candidate tokens with the highest probability as a probability of a first target token.

In one embodiment, according to the first decoding algorithm, a preset threshold is randomly selected between 0 and 1. From a probability distribution of a plurality of candidate tokens of the first token, a plurality of probabilities having probabilities greater than the preset threshold are identified. A candidate token is randomly selected from the identified candidate tokens as the first target token, and the first probability equals 1 divided by the number of the identified candidate tokens.

S202: outputting candidate tokens having a maximum candidate weight among candidate weights for a second token as a second target token with a second probability using the second decoding algorithm.

The first probability is less than or equal to the second probability.

In one embodiment, a maximum candidate weight among candidate weights for a second token represents a highest probability in a probability distribution of a plurality of candidate tokens for the second token. The second probability represents a probability that a candidate token having the highest probability is selected as the second target token.

In one embodiment, according to the second decoding algorithm, a candidate token having a highest probability in a probability distribution of a plurality of candidate tokens for a second token is selected as a second target token with a second probability.

For example, candidate tokens for the second token may include tokens E, F, and G with respective probabilities 0.35, 0.45, and 0.2. The candidate token having the highest probability, token F, is selected as the second target token. Accordingly, the second probability of the selected candidate token having the highest probability is 1 (i.e., 100%).

In one embodiment, for the first tokens representing the target tokens, the first decoding algorithm outputs, with the first probability, a candidate token having a maximum candidate weight among candidate weights of candidate tokens for a first token as the first target token. Similarly, for the second tokens corresponding to the guessing tokens, the second decoding algorithm outputs, with the second probability, a candidate token having a maximum candidate weight among candidate weights of candidate tokens for a second token as a second target token.

Because the first probability is less than or equal to the second probability, and because the first decoding algorithm and the second decoding algorithm utilize candidate weights in different manners, decoding the second token according to the second decoding algorithm can reduce an on generation of the target token using the first decoding algorithm, thereby improving accuracy during inference.

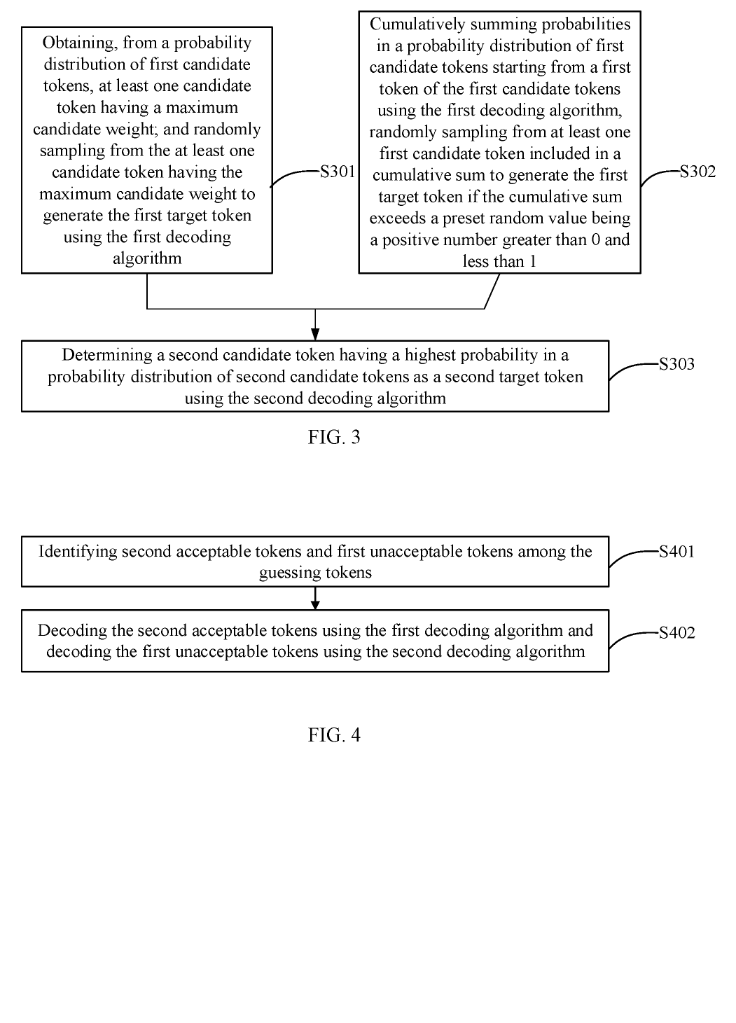

FIG. 3 illustrates a flowchart of another token generation method consistent with various embodiments of the present disclosure. The method can be executed by a processor of a computer device. The candidate weights for the first token, as described with reference to FIG. 2, may include a probability distribution of candidate tokens generated by the target model conditioned on the first token. The candidate weights for the second token may include a probability distribution of candidate tokens generated by the target model conditioned on the second token. In some embodiments, step S201 shown in FIG. 2 may be updated to step S301 or step S302, and step S202 shown in FIG. 2 may be updated to step S303, which are described below with reference to FIG. 3.

S301: obtaining, from a probability distribution of first candidate tokens, at least one candidate token having a maximum candidate weight; and randomly sampling from the at least one candidate token having the maximum candidate weight to generate the first target token using the first decoding algorithm,

In one embodiment, according to the first decoding algorithm, a first random number is generated, where the first random number is greater than 0 and less than 1. From a probability distribution of first candidate tokens, at least one first candidate token is obtained, each having a probability greater than or equal to the first random number. A second random number is also generated, where the second random number is greater than 0 and less than 1. Based on the second random number, the first target token is selected from the at least one first candidate token. If the at least one first candidate token having probabilities greater than or equal to the first random number include three candidate tokens, the candidate token having a probability value closest to the second random number is selected as the first target token.

For example, the first random number is 0.2, and a probability distribution of the first candidate tokens is 0.1, 0.15, 0.2, 0.25, and 0.3. The first candidate tokens having probabilities greater than or equal to 0.2 are retained, resulting in a retained probability set of 0.2, 0.25, and 0.3. If the second random number is 0.23, the first candidate token having the probability 0.25 is selected as the first target token.

S302: cumulatively summing probabilities in a probability distribution of first candidate tokens starting from a first token of the first candidate tokens using the first decoding algorithm, randomly sampling from at least one first candidate token included in a cumulative sum to generate the first target token if the cumulative sum exceeds a preset random value being a positive number greater than 0 and less than 1.

In one embodiment, a first preset random value between 0 and 1 is generated. In a probability distribution of first candidate tokens sorted from smallest to largest, probabilities are cumulatively summed starting from a smallest-probability first candidate token until a cumulative sum is greater than or equal to the first preset random value. A second preset random value between 0 and 1 is generated. From the first candidate tokens involved in the cumulative sum, a first candidate token having a probability closest to the second preset random value is determined as the first target token.

For example, the first preset random value is 0.65. A probability distribution of the first candidate tokens, sorted from smallest to largest, is 0.1, 0.15, 0.2, 0.25, and 0.3. Probabilities are cumulatively summed until the cumulative sum is greater than or equal to 0.65. In the example, the first candidate tokens included in the cumulative sum correspond to probabilities 0.1, 0.15, 0.2, and 0.25. The second preset random value is 0.18. A first candidate token having a probability closest to 0.18, which is 0.2, is selected as the first target token.

S303: determining a second candidate token having a highest probability in a probability distribution of second candidate tokens as a second target token using the second decoding algorithm.

In one embodiment, using the second decoding algorithm, a second candidate token having a highest probability in a probability distribution of second candidate tokens is selected as the second target token.

For example, if the probability distribution of the second candidate tokens is 0.25, 0.35, and 0.4, a second candidate token having the probability of 0.4 is selected as the second target token.

In one embodiment, when a plurality of second candidate tokens share a highest probability, the second decoding algorithm selects the second target token by either randomly selecting one of the plurality of second candidate tokens or selecting a predetermined one of the plurality of second candidate tokens.

For example, if second candidate tokens include tokens A, B, and C with respective probabilities 0.3, 0.35, and 0.35, either token B or token C (each having the highest probability 0.35) may be randomly selected as the second target token, or token B may be selected as the second target token.

In one embodiment, random numbers are used during decoding of a probability distribution of first candidate tokens using the first decoding algorithm. When decoding probability distributions of a plurality of first candidate tokens, a random number is generated for each probability distribution of the plurality of first candidate tokens, thereby producing a sequence of random numbers. Accordingly, the second decoding algorithm does not require generating random numbers when decoding a probability distribution of second candidate tokens. As a result, random numbers that would otherwise be generated during decoding of the probability distribution of the second candidate tokens do not affect the sequence of random numbers generated during decoding of probability distributions of the first candidate tokens, thereby improving accuracy of generating target tokens during inference.

FIG. 4 illustrates a flowchart of another token generation method consistent with various embodiments of the present disclosure. The method can be executed by a processor of a computer device. The first tokens represent acceptable tokens output from a previous inference stage, and the second tokens represent guessing tokens output from a previous inference stage. The method includes steps S401 and S402, which will be explained in conjunction with the steps shown in FIG. 4.

S401: identifying second acceptable tokens and first unacceptable tokens among the guessing tokens.

In one embodiment, a probability distribution of a last token in the first tokens is decoded using the first decoding algorithm to obtain a last acceptable token in the first tokens. If the last acceptable token differs from a first guessed token in the second tokens, all guessed tokens in the second tokens are designated as first unacceptable tokens.

If a last acceptable token is the same as a first guessing token in the second tokens, the first guessing token is a first token of the second acceptable tokens. A probability distribution of the first guessing tokens is decoded using the first decoding algorithm to obtain a second acceptable token. If a second acceptable token is the same as a second guessing token, the second guessing token is designated as a third token of the second acceptable tokens. If the second acceptable tokens are different from the second guessing tokens, the second guessing tokens and all subsequent guessing tokens are designated as first unacceptable tokens and repeat a second process to identify the second acceptable tokens and the first unacceptable tokens among the guessing tokens.

S402: decoding the second acceptable tokens using the first decoding algorithm and decoding the first unacceptable tokens using the second decoding algorithm.

In one embodiment, using the first decoding algorithm, at least one candidate token having a highest weight is obtained from a probability distribution of candidate tokens for a second acceptable token. Random sampling is performed on the at least one candidate token with the highest weight to obtain a next acceptable token of the second acceptable tokens.

In one embodiment, in the probability distribution of the candidate tokens for a second acceptable token, probabilities are accumulated starting from a probability of a first candidate token. When the accumulated value exceeds a preset random value, at least one of the accumulated candidate tokens is randomly sampled to generate next acceptable tokens for the second acceptable token. The preset random value is a positive number greater than 0 and less than 1.

In one embodiment, using the second decoding algorithm, a candidate token having a highest probability from a probability distribution of candidate tokens for a first unacceptable token is determined as a next token of the first unacceptable token.

In one embodiment, acceptable tokens and unacceptable tokens are identified from among the guessing tokens. The first decoding algorithm is applied to the acceptable tokens, and the second decoding algorithm is applied to the unacceptable tokens. Since the first decoding algorithm generates a sequence of random numbers, using the second decoding algorithm for the unacceptable tokens prevents a sequence of random numbers generated during the first decoding process from affecting the sequence of random numbers generated when decoding the acceptable tokens, thereby improving accuracy of token generation during model inference process.

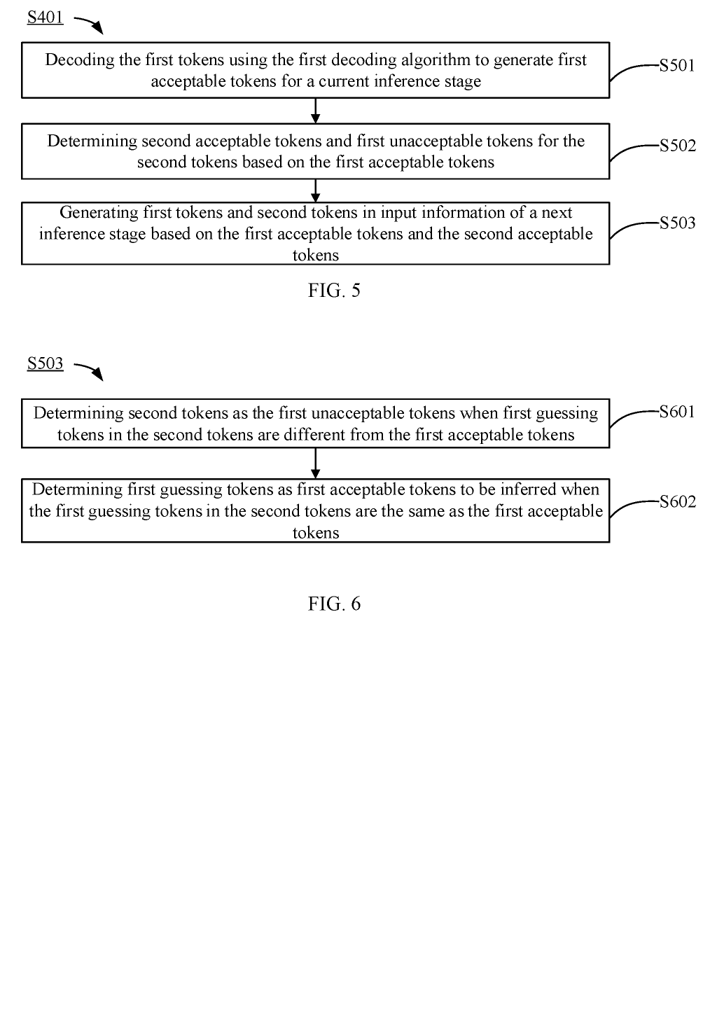

FIG. 5 illustrates a flowchart of another token generation method consistent with various embodiments of the present disclosure. The method can be executed by a processor of a computer device. Referring to FIG. 4, step S401 may be updated to include steps S501 through S503, which are described below with reference to FIG. 5.

S501: decoding the first tokens using the first decoding algorithm to generate first acceptable tokens for a current inference stage.

In one embodiment, using the first decoding algorithm, at least one candidate token having a maximum candidate weight is obtained from a probability distribution of candidate tokens for a first token. The at least one candidate token with the maximum candidate weight is randomly sampled to obtain a next first acceptable token for the first tokens.

In one embodiment, in the probability distribution of the candidate tokens for a first token, probabilities of first candidate tokens are cumulatively summed. When the cumulative sum exceeds a preset random value, the at least one candidate token included in the cumulative sum is randomly sampled to generate a next first acceptable token. The preset random value is a positive number greater than 0 and less than 1.

S502: determining second acceptable tokens and first unacceptable tokens for the second tokens based on the first acceptable tokens.

In one embodiment, if a first token of first acceptable tokens is different from a first token of the second tokens, all the second tokens are first unacceptable tokens. If the last acceptable tokens are the same as the first guessing tokens in the second tokens, the first guessing tokens are first second acceptable tokens. A probability distribution of the first guessing tokens is decoded using the first decoding algorithm to obtain a second token of the second acceptable tokens. If a second token of the second acceptable tokens is the same as a second token of the second tokens, the second token is considered a third token of the second acceptable token. If the second token of the second acceptable tokens is different from the second token of the second tokens, by treating the second guessing token and all subsequent tokens as the first unacceptable tokens and repeating a second process to determine all second acceptable tokens and to all first unacceptable tokens among the second tokens.

S503: generating first tokens and second tokens in input information of a next inference stage based on the first acceptable tokens and the second acceptable tokens.

In one embodiment, the first acceptable tokens and the second acceptable tokens are used as first tokens in input information for a next inference stage. Based on the first acceptable tokens and the second acceptable tokens, a plurality of subsequent tokens after the second acceptable tokens are predicted according to a contextual relationship to obtain a plurality of guessing tokens. The plurality of guessing tokens is used as second tokens in the next inference stage.

For example, the first acceptable tokens include tokens A, B, and C, and the second acceptable tokens include tokens C and D. Tokens A, B, C, and D are used as the first tokens in input information for a next inference stage. Based on tokens A, B, C, and D, a token following token D is predicted to obtain guessing tokens E, F, and G, and tokens E, F, and G are used as the second tokens in the input information for the next inference stage.

In one embodiment, a probability distribution of the first tokens is decoded using the first decoding algorithm to obtain the first acceptable tokens. Based on the first acceptable tokens, the second acceptable tokens and the first unacceptable tokens are identified from among the second tokens. The second acceptable tokens are decoded using the first decoding algorithm, and the first unacceptable tokens are decoded using the second decoding algorithm. Since the first decoding algorithm generates a sequence of random numbers during decoding, the second decoding algorithm is used to decode unacceptable tokens, thereby preventing the sequence of random numbers generated by the first decoding algorithm from affecting the sequence of random numbers generated when decoding acceptable tokens, and improving an accuracy of token generation during a model inference process. The first acceptable tokens and the second acceptable tokens are used as first tokens in input information for a next inference stage. Based on the first acceptable tokens and the second acceptable tokens, second tokens for the next inference stage are generated, thereby improving inference speed of the next inference stage.

FIG. 6 illustrates a flowchart of another token generation method consistent with various embodiments of the present disclosure. The method may be performed by a processor of a computer device. Referring to FIG. 5, step S503 may be updated to step S601 or step S602, as described below with reference to FIG. 6.

S601: determining second tokens as the first unacceptable tokens when first guessing tokens in the second tokens are different from the first acceptable tokens.

In one embodiment, the first acceptable tokens represent next acceptable tokens after the last token in the first tokens, and the first guessing tokens represent next guessing tokens after the last token in the first tokens. If the first acceptable tokens are different from the first guessing tokens, next tokens after the last token in the first tokens are predicted incorrectly. That is, the first guessing tokens and all subsequent guessing tokens after the first guessing tokens are predicted incorrectly. Accordingly, all guessing tokens in the second tokens are determined to be the first unacceptable tokens.

S602: determining first guessing tokens as first acceptable tokens to be inferred when the first guessing tokens in the second tokens are the same as the first acceptable tokens.

The first acceptable tokens to be inferred are decoded to generate second acceptable tokens using the first decoding algorithm. A process of comparing the second acceptable tokens with the next target guessing tokens of the first acceptable token to be inferred in the second token is repeatedly performed. If the target guessing tokens are the same as the second acceptable tokens, the target guessing tokens are determined to be the first acceptable tokens to be inferred. If the target guessing token is different from the second acceptable token, the target guessing tokens and the guessing tokens after the target guessing tokens in the second tokens are determined to be the first unacceptable tokens.

In one embodiment, the second tokens include a plurality of candidate tokens, where the plurality of candidate tokens is the next guessing tokens after the last token in the first tokens. For example, the first tokens are tokens A and B, and guessing tokens after tokens A and B include tokens C and D. A next correct token after tokens A and B is token X. If token X is the same as a first guessing token, the first guessing token is predicted correctly. The first guessing token is decoded using the first decoding algorithm to obtain a first token of the second acceptable tokens. A second guessing token is used as a target guessing token and compared with a second token of the second acceptable tokens. If the target guessing token is the same as the second token of the second acceptable tokens, a next acceptable token after the first token of the second acceptable tokens is predicted correctly and the target guessing token is determined to be a second token of the second guessing tokens.

In one embodiment, if a first guessing token in the second tokens is the same as a first acceptable token, indicating that a next token after the last token in the first tokens is predicted correctly, the first guessing tokens is used as a next acceptable token after the last token in the first tokens, i.e., the first guessing token is used as a first token of the second acceptable tokens. The probability distribution for the first guessing tokens is used in the first decoding algorithm to obtain a second token of the second acceptable tokens. The second token of the second acceptable tokens is a next acceptable token after the first token of the second acceptable tokens, and the second guessing token is a next guessing token after the first token of the second acceptable tokens. If the second token of the second acceptable token is the same as the second guessing token, the next acceptable tokens after the first token of the second acceptable tokens is predicted correctly, indicating that the second guessing token is the second token of the second acceptable tokens using the second decoding algorithm, a probability distribution of the second guessing tokens is decoded to obtain a third token of the second acceptable tokens. The third token of the second acceptable tokens represents a next acceptable token after the second token of the second acceptable tokens, and a third guessing token represents a next guessing token after the second token of the second guessing tokens. The third token of the second acceptable tokens is compared with the third guessing token, and the above process is repeated until an n-th acceptable token differs from an (n-1)-th guessing token. The (n-1)-th guessing token and all subsequent tokens are considered the first unacceptable tokens and n is a natural number greater than 0.

In one embodiment, by comparing the first acceptable tokens with next tokens predicted following the last token in the first tokens, the second acceptable tokens and the first unacceptable tokens are identified from the second tokens. Based on the determination, the second acceptable tokens are decoded using the first decoding algorithm, and the first unacceptable tokens are decoded using the second decoding algorithm. Because the first decoding algorithm generates a sequence of random numbers, and the second decoding algorithm is used to decode unacceptable tokens, random numbers that would otherwise be generated during decoding of the unacceptable tokens do not perturb the sequence of random numbers used when decoding acceptable tokens, thereby improving accuracy of token generation during a model inference process.

In one embodiment, after generating acceptable tokens, the method further includes: outputting first acceptable tokens as target data if the first acceptable tokens meet a preset requirement.

In one embodiment, the first acceptable tokens represent next tokens after the last tokens in the first tokens.

In one embodiment, the preset requirement may be that after generating the first acceptable tokens, if a total number of tokens in the first tokens together with the first acceptable tokens reaches a preset number, model inference is terminated, and the first tokens and the first acceptable tokens are output as the target data.

In one embodiment, the preset requirement may also be an end-of-inference signal indicated by the first acceptable tokens. For example, when the first acceptable tokens include a punctuation mark such as a comma, period, or semicolon, model inference is terminated after obtaining the first acceptable tokens, and the first tokens and the first acceptable tokens are used as the target data.

If the second acceptable tokens satisfy the preset requirement, the first acceptable tokens and the second acceptable tokens are output as the target data in a token generation order.

In one embodiment, the preset requirement may be that after generating the second acceptable tokens, if a total number of the first tokens, the first acceptable tokens, and the second acceptable tokens reaches a preset quantity, model inference is terminated, and the first tokens, the first acceptable tokens, and the second acceptable tokens are output as the target data.

In one embodiment, the preset requirement can also be an end-of-inference marker indicated by a last token in the second acceptable tokens. For example, when the last token in the second acceptable tokens include a punctuation mark such as a comma, period, or semicolon, model inference is terminated after obtaining the last token in the second acceptable tokens, and the first tokens, the first acceptable tokens, and the second acceptable tokens are used as the target data.

In one embodiment, acceptable tokens in an output are detected. After the first acceptable tokens or the second acceptable tokens satisfy the preset requirement, currently generated acceptable tokens and the first tokens are output as the target data in a token generation order, thereby avoiding generation of additional tokens and improving model inference accuracy, and reducing resource consumption.

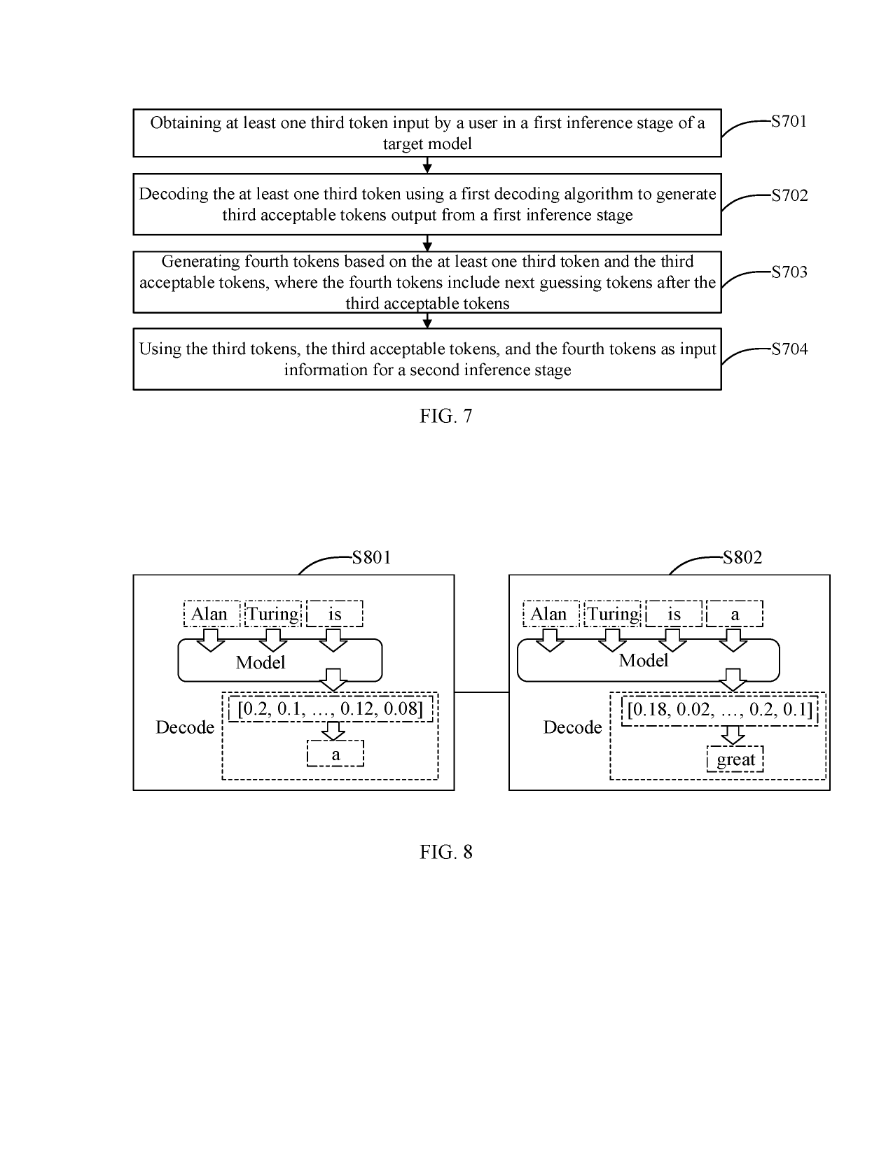

FIG. 7 illustrates a flowchart of another token generation method consistent with various embodiments of the present disclosure. The method can be executed by a processor of a computer device. The method includes steps S701 through S704, which are described below with reference to FIG. 7.

S701: obtaining at least one third token input by a user in a first inference stage of a target model.

In one embodiment, after the target model responds to an inference instruction from an inference user, speech information and text information input by a user are obtained and converted into at least one third token.

For example, if the speech information input by a user is “eat tonight”, the speech information is converted into two third tokens, for example, “eat” and “tonight”.

S702: decoding the at least one third token using a first decoding algorithm to generate third acceptable tokens output from a first inference stage.

In one embodiment, the target model obtains a probability distribution of a plurality of candidate tokens for a next token in the third token based on a vocabulary. The probability distribution of the plurality of candidate tokens is decoded using the first decoding algorithm to obtain next acceptable tokens after a last token in the third tokens, which are the third acceptable tokens.

S703: generating fourth tokens based on the at least one third token and the third acceptable tokens, where the fourth tokens include next guessing tokens after the third acceptable tokens.

In one embodiment, based on a contextual semantic relationship between at least one third token and the third acceptable tokens, the target model predicts next tokens for the third acceptable tokens from a vocabulary to obtain one or more guessing tokens, referred to as fourth tokens. Specifically, based on the contextual semantic relationship between at least one third token and the third acceptable tokens, a probability distribution of a plurality of candidate tokens for a next token after the third acceptable token is obtained from the vocabulary. The probability distribution is decoded using a greedy selection method to obtain predicted next tokens after the third acceptable tokens, which are the fourth tokens.

S704: using the third tokens, the third acceptable tokens, and the fourth tokens as input information for a second inference stage.

In one embodiment, user input token, the third tokens, and the third acceptable tokens are used as the first tokens in the input information for the second inference stage, and the fourth tokens are used as the second tokens in the input information for the second inference stage. The first tokens are decoded using the first decoding algorithm, and the second tokens are decoded using the second decoding algorithm, to obtain target tokens output by the second inference stage.

In the embodiment, the user input tokens are obtained. Based on contextual semantic relationships of the user input tokens, the target model obtains, from a vocabulary, a probability distribution of candidate next tokens. A first weighted random sampling algorithm is used to decode a probability distribution of next tokens after the user input tokens, resulting in the third acceptable tokens. Based on the user input tokens and the third acceptable tokens, next tokens after the third acceptable tokens are predicted to obtain the fourth tokens. The user input tokens, the third acceptable tokens, and the fourth tokens are used as input information for the second inference stage to decode the first tokens using the first decoding algorithm and decode the second tokens using the second decoding algorithm, thereby obtaining a target token output from the second inference stage and improving accuracy of generating acceptable tokens during a model inference process.

In one embodiment, after generating the third tokens and the third acceptable tokens as described above, the method further includes: determining whether the third acceptable tokens satisfy a preset requirement, and in response to determining that the third acceptable tokens satisfy the preset requirement, outputting the third tokens and the third acceptable tokens as target data.

In one embodiment, the preset requirement may be that after generating the third acceptable tokens, if a total number of tokens including the third tokens and the third acceptable tokens reaches a preset quantity, model inference is terminated, and the third token and the third acceptable token are output as the target data.

In one embodiment, the preset requirements may also specify that the third acceptable token serves as a signal to end an inference process. For example, when a third acceptable token is a punctuation mark such as a comma, period, or semicolon, model inference is terminated after obtaining the third acceptable tokens, and the third tokens and the third acceptable tokens are used as the target data.

In the embodiment, by detecting output third acceptable tokens, and if the third acceptable token meets the preset requirement, the currently generated third acceptable tokens and the third tokens are output as the target data in a token generation order, thereby avoiding generation of additional tokens and improving model inference accuracy, and reducing resource consumption.

The following describes an exemplary application of the token generation method provided in one embodiment in a practical scenario.

Currently, a large language model generates tokens sequentially, resulting in relatively slow generation. The latency can significantly impact user experience, particularly on edge devices with limited computing resources. The following describes an inference process of a large language model. The model generates a next token based on previous input and uses the next token as input to generate a subsequent token. FIG. 8 illustrates a schematic diagram of an inference process consistent with various embodiments of the present disclosure. Process 801 represents generating a first token based on user input tokens, and process 802 represents generating a second token based on the user input tokens and the first generated token. It should be understood that the inference model determines, based on the user input tokens and the first generated token, a probability distribution of at least one candidate token after the first token. The probability distribution of at least one candidate token is decoded using a weighted random sampling algorithm to obtain a next token after the first token. Process 802 is repeated until inference is complete.

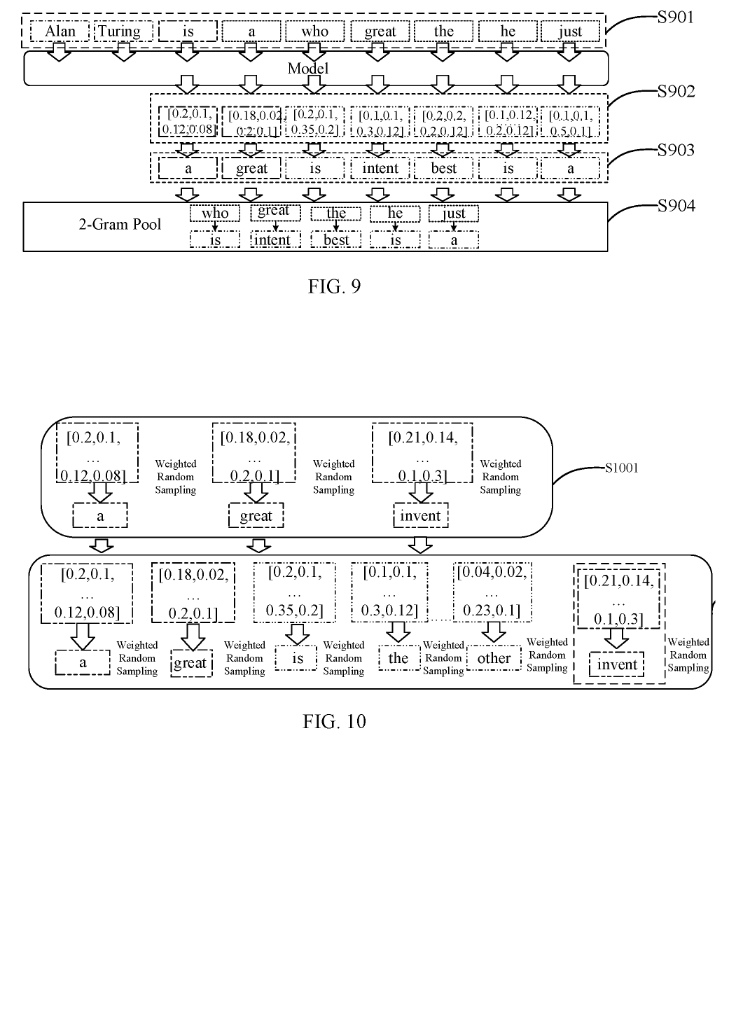

Currently, a common and classic approach for accelerating inference is lookahead prediction, which speeds up the inference computation of large language models. The following describes a large language model inference acceleration process using lookahead. In addition to predicting a next token of a current token, a lookahead process also generates speculative future tokens. When the speculative future tokens are confirmed as correct, a single inference can produce a plurality of output tokens, thereby increasing generation throughput relative to conventional inference in which an inference cycle outputs only one token. FIG. 9 illustrates a schematic diagram of another inference process consistent with various embodiments of the present disclosure. Process 901 represents the input information for the current inference stage, including user input, a first correct token generated based on the user input, and multiple guessing tokens derived from the user input and the first correct token. Process 902 represents the probability distribution of a next token for each token in the input information obtained through model inference. The probability distributions are decoded using a weighted random sampling algorithm to obtain output tokens, which include both correct tokens and incorrect tokens. Based on user input tokens and correct tokens, next guessing tokens after the correct tokens are generated, and the user input tokens, the output correct tokens, and the guessing tokens are used as input information for a next inference stage. Process 904 represents incorrect guessing tokens in all inference stages, as well as incorrect tokens obtained by decoding probability distributions of the incorrect guessing tokens using a weighted random sampling algorithm. During decoding, incorrect guessing tokens are also decoded using the weighted random sampling algorithm. Random numbers consumed during decoding of the incorrect guessing tokens perturb a sequence of random numbers used to decode correct tokens, thereby reducing inference accuracy.

Traditional inference acceleration methods may decode correct tokens using the weighted random sampling algorithm. Specifically, the weighted random sampling algorithm used in a decoding process is a technique that considers probabilities of different tokens when selecting a token. In other words, tokens are randomly selected based on weights with tokens having higher weights being more likely to be selected. The random number generator used in the decoding process may be deterministic. For example, given a same seed, the random number generator generates a same sequence of random numbers. However, a lookahead method decodes additional guessing tokens, which consumes random numbers and thereby perturbs the sequence of random numbers used to decode correct tokens. As a result, tokens ultimately output by the lookahead method may differ from tokens output by an original inference method, thereby reducing inference accuracy.

FIG. 10 illustrates a schematic diagram of a decoding process consistent with various embodiments of the present disclosure. Process 1001 includes decoding probability distributions of correct tokens using a weighted random sampling algorithm. For each probability distribution, a random number is generated to determine a next token. Process 1002 includes decoding probability distributions of both correct tokens and incorrect tokens using the weighted random sampling algorithm. If each token is decoded using weighted random sampling, the sequence of random numbers used for decoding the probability distribution of the correct tokens differs from the sequence of random numbers used for the correct tokens in process 1001. As a result, different correct tokens may be generated, which can reduce inference accuracy.

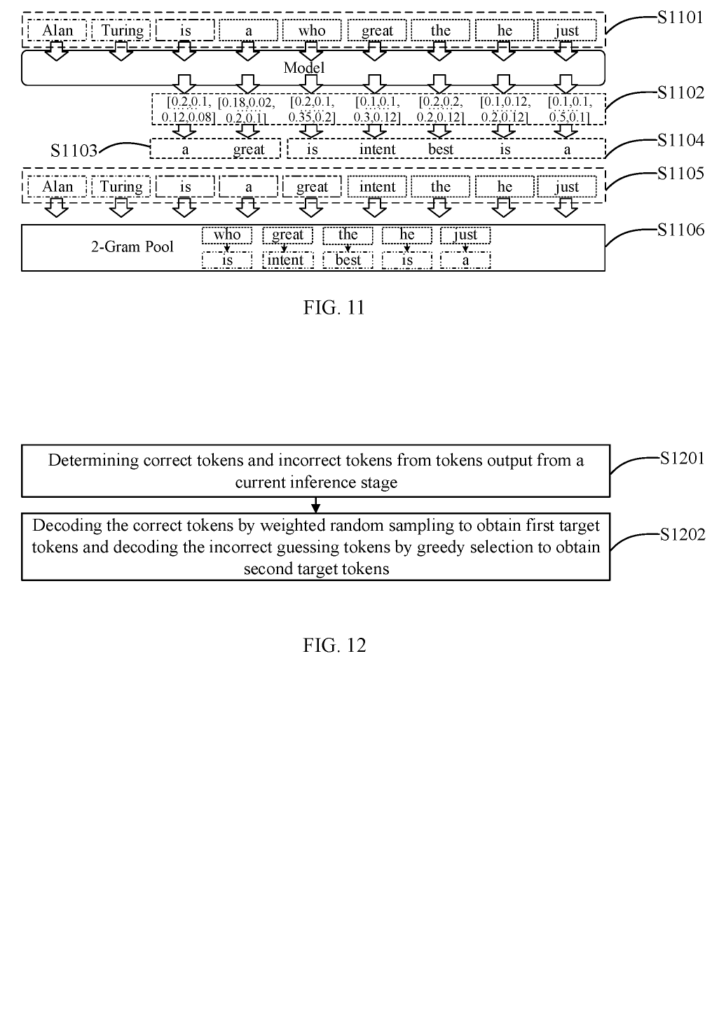

FIG. 11 illustrates a schematic diagram of another inference process consistent with various embodiments of the present disclosure. Process 1101 represents input information for a current inference stage, including user input tokens, first correct tokens generated based on the user input tokens, and a plurality of guessing tokens derived from the user input tokens and the first correct tokens. Process 1102 represents probability distributions of candidate next tokens for respective tokens in the input information obtained through model inference. Process 1103 includes decoding, using weighted random sampling, a probability distribution of the first correct tokens to obtain second correct tokens. If the second correct tokens are the same as the first guessing tokens, the process 1103 further includes decoding, using weighted random sampling, a probability distribution of the first guessing tokens to obtain third correct tokens. The process of repeatedly comparing correct tokens with guessing tokens and decoding a probability distribution of the same guessing token continues until the obtained correct tokens differ from the guessing tokens. Process 1104 includes the incorrect tokens obtained by decoding probability distributions of incorrect guessing tokens in a guessing token sequence using a greedy selection method. Process 1105 represents input information for a next inference stage, including user input tokens, first correct tokens output by a previous inference stage, second correct tokens, and guessing tokens obtained based on the user input tokens, the first correct tokens, and the second correct tokens. Process 1106 represents incorrect guessing tokens across all inference stages, as well as incorrect tokens obtained by decoding probability distributions of the guessing tokens using a greedy selection method.

FIG. 12 illustrates a flowchart of another token generation method consistent with various embodiments of the present disclosure. The method can be executed by a processor of a computer device. The method includes steps S1201 and S1202, which are described below with reference to FIG. 12.

S1201: determining correct tokens and incorrect tokens from tokens output from a current inference stage.

In one embodiment, input information for a current inference stage includes tokens 1, 2, 3, 4, 5, and 6, where tokens 1 and 3 are user input tokens, token 2 is a correct token derived from tokens 1 and 2, and tokens 4, 5, and 6 are guessing tokens derived from tokens 1, 2, and 3. The model obtains, for each of tokens 1–6, a probability distribution of candidate next tokens, and decodes a probability distribution of token 3 using weighted random sampling to obtain a first correct output token. If the first correct output token matches token 4, token 4 is confirmed as correct. If the first correct output token differs from token 4, tokens 4–6 are designated as incorrect tokens.

S1202: decoding the correct tokens by weighted random sampling to obtain first target tokens and decoding the incorrect guessing tokens by greedy selection to obtain second target tokens.

In one embodiment, if the first correct token is the same as token 4, a probability distribution of a first pair of 4s is decoded through weighted random sampling to obtain the second correct tokens. The second correct tokens are compared with the second guessing token 5. If the second correct tokens are different from the second guessing token, both tokens 5 and 6 are predicted incorrectly. The probability distribution of tokens 5 and 6 is decoded through greedy selection to obtain a next incorrect token for the token 5 and a next incorrect token for the token 6.

In one embodiment, during a model inference process, tokens obtained after model inference are classified into correct tokens and incorrect tokens. Probability distributions of the correct tokens are decoded using a weighted random sampling algorithm to obtain output tokens, and probability distributions of the incorrect tokens are decoded using a greedy selection method to obtain output tokens. By using the greedy selection method for the incorrect tokens, random numbers that would otherwise be consumed during decoding of the incorrect tokens do not perturb a sequence of random numbers used to decode the correct tokens via weighted random sampling, thereby maintaining inference speed while improving inference accuracy.

Based on the above embodiments, the present disclosure further provides a token generation device including various units and modules within the various units. The token generation device may be implemented by a processor of a computer device. Alternatively, the token generation device may be implemented using dedicated logic circuits. During implementation, the processor may be a central processing unit (CPU), a microprocessor unit (MPU), a digital signal processor (DSP), a field-programmable gate array (FPGA), or the like.

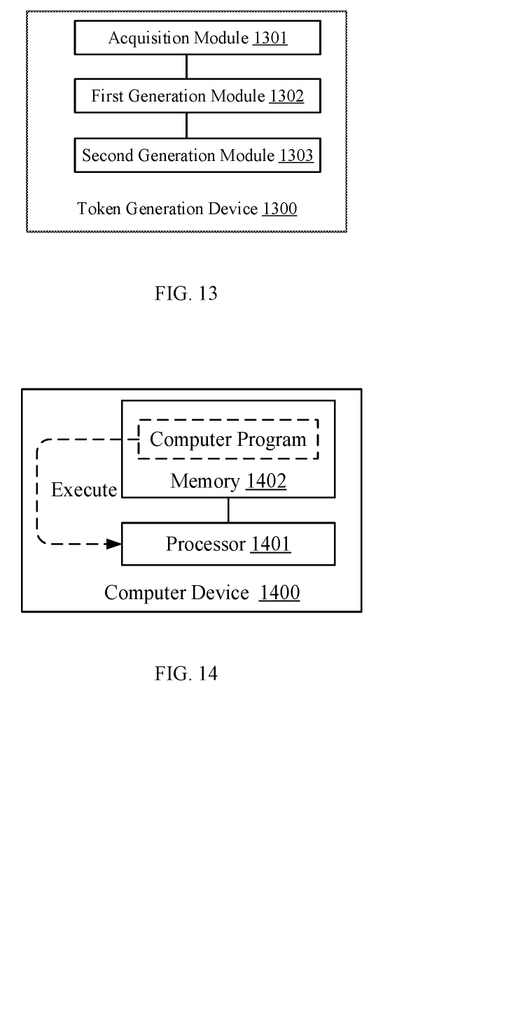

FIG. 13 illustrates a schematic diagram of a token generation device consistent with various embodiments of the present disclosure. As shown in FIG. 13, the token generation device 1300 includes: an acquisition module 1301, a first generation module 1302, and a second generation module 1303. The acquisition module 1301 is configured to obtain input information for a current inference stage of the target model. The input information includes first tokens and second tokens. The first tokens include the target tokens output from a previous inference stage. The second tokens include guessing tokens output from the previous inference stage. The first generation module 1302 is configured to generate candidate weights for the first tokens and the second tokens based on inference performed by the target model. The candidate weights represent probabilities of respective candidate tokens becoming target tokens. The second generation module 1303 is configured to decode candidate weights of the first tokens using a first decoding algorithm to generate first target tokens, and to decode candidate weights of the second tokens using a second decoding algorithm to generate second target tokens. The first decoding algorithm is different from the second decoding algorithm.

In one embodiment, the second generation module 1303 is further configured to output the candidate token with a maximum candidate weight among the candidate weights of the first tokens as the first target tokens based on a first probability using the first decoding algorithm; and to output the candidate tokens with the maximum candidate weight among the candidate weights of the second tokens as the second target tokens based on a second probability using the second decoding algorithm. The first probability is less than or equal to the second probability.

In one embodiment, the candidate weights for the first tokens include the probability distribution of first candidate tokens obtained after the target model performs inference on the first tokens. The candidate weights for the second tokens include the probability distribution of the second candidate tokens obtained after the target model performs inference on the second tokens. The second generation module 1303 is further configured to output the first target tokens using the first decoding algorithm. The candidate tokens having a maximum candidate weight among the candidate weights of the first tokens are output as the first target tokens based on the first probability. The first decoding algorithm includes at least one of the following: obtaining, from a probability distribution of the first candidate tokens, at least one candidate token having the maximum candidate weight and randomly sampling from the at least one candidate token having the maximum candidate weight to generate the first target tokens; or, cumulatively summing probabilities in a probability distribution of the first candidate tokens starting from a first token of the first candidate tokens, and, when the cumulative sum exceeds a preset random value, randomly sampling from at least one first candidate token included in the cumulative sum to generate the first target tokens. The preset random value is a positive number greater than 0 and less than 1. A process of determining the candidate tokens with the maximum candidate weight among the candidate weights of the second tokens using the second decoding algorithm and the second probability includes: determining the second candidate tokens with a highest probability from the probability distribution of the second candidate tokens as the second target tokens.

In one embodiment, the first tokens represent acceptable tokens output from a previous inference stage, and the second token represent guessing tokens output from a previous inference stage. The second generation module 1303 is further configured to identify second acceptable tokens and first unacceptable tokens among the guessing tokens. The second acceptable tokens are decoded using the first decoding algorithm, and the first unacceptable tokens are decoded using the second decoding algorithm.

In one embodiment, the second generation module 1303 is further configured to decode the first tokens using the first decoding algorithm to generate first acceptable tokens for a current inference stage; determine second acceptable tokens and first unacceptable tokens from the second tokens based on the first acceptable tokens; and generate the first tokens and the second tokens in the input information for a next inference stage based on the first acceptable tokens and the second acceptable tokens.

In one embodiment, the second generation module 1303 is further configured to determine the first guessing tokens in the second tokens to be the first unacceptable tokens when the first guessing token differs from the first acceptable tokens; determine the first guessing tokens to be the first acceptable tokens to be inferred when the first guessing tokens are the same as the first acceptable tokens; generate the second acceptable tokens by decoding first acceptable token to be inferred using the first decoding algorithm; repeatedly compare the second acceptable tokens with next target guessing tokens after the first acceptable tokens to be inferred in the second tokens, determine the target guessing tokens to be the first acceptable tokens to be inferred if the target guessing tokens are the same as the second acceptable tokens; and determine the target guessing tokens and all subsequent guessing tokens in the second tokens to be the first unacceptable tokes if the target guessing tokens are different from the second acceptable tokens.

In one embodiment, the token generation device 1300 further includes a first output module (not shown), which is configured to output the first acceptable tokens as target data if the first acceptable tokens meet a preset requirement; and output the first acceptable tokens and the second acceptable tokens as target data in an token generation order if the second acceptable tokens meet the preset requirement.

In one embodiment, the second generation module 1303 is further configured to obtain at least one third token input by a user during a first inference stage of the target model; decode the third tokens using the first decoding algorithm to generate third acceptable tokens output in a first inference stage; generate fourth tokens based on the third tokens and the third acceptable tokens; the fourth tokens includes next guessing tokens after the third acceptable tokens; and use the third tokens, the third acceptable tokens, and the fourth tokens as input information for a second inference stage.

In one embodiment, the token generation device 1300 further includes a second output module (not shown), which is configured to output the third tokens and the third acceptable tokens as target data when the third acceptable tokens meet the preset requirement.

The description of the device embodiments above is similar to the description of the method embodiments, and they have similar beneficial effects. In some embodiments, the device provided in the embodiments of the present disclosure has functions or includes modules that can be used to perform the methods described in the method embodiments. For technical details not disclosed in the device embodiments, reference may be made to the description of the method embodiments.

It should be noted that, in the embodiments of the present disclosure, when the above methods are implemented as software functional modules and sold or used as an independent product, the software functional modules may be stored on a computer-readable storage medium. Therefore, the technical solutions disclosed herein, or a portion thereof contributing to the relevant technology, may be embodied as a software product. The software product may be stored on a computer-readable storage medium and may include instructions that, when executed by one or more processors of a computer device (e.g., a personal computer, a server, or a network device), cause the computer device to perform all or part of the methods described in the embodiments of the present disclosure. Example storage media include a USB drive, an external hard drive, read-only memory (ROM), a magnetic disk, an optical disc, or other media capable of storing program code. Accordingly, the embodiments of the present disclosure are not limited to any specific hardware, software, firmware, or any combination thereof.

In one embodiment, a computer device is provided that includes a memory and a processor. The memory stores computer-executable instructions that, when executed by the processor, cause the computer device to perform some or all of the steps of the methods described above.

In one embodiment, a computer-readable storage medium is provided that stores a computer program with instructions that, when executed by a processor, cause performance of some or all of the steps of the method described above. The computer-readable storage medium may be transient or non-transient.

In one embodiment, a computer program including computer-readable code is provided, which, when executed on a computer device, causes a processor in the computer device to perform some or all of the steps of the method described above.

In one embodiment, a computer program product is provided that includes a non-transitory computer-readable storage medium storing a computer program. When the computer program is read and executed by a computer device, the computer device performs some or all of the steps of the method described above. The computer program product may be implemented using hardware, software, or a combination thereof. In some embodiments, the computer program product is embodied as the non-transitory computer-readable storage medium. In other embodiments, the computer program product is embodied as a software product, such as a software development kit (SDK), or the like.

It should be noted that the above embodiments emphasize differences among the embodiments. Features not expressly described in a particular embodiment may be understood with reference to other embodiments. The device, storage medium, computer program, and computer program product embodiments generally correspond to the method embodiments and may provide similar beneficial effects. For technical details not expressly described in the device, storage medium, computer program, and computer program product embodiments, reference may be made to corresponding descriptions of the method embodiments.

FIG. 14 illustrates a schematic diagram of hardware components of a computer device consistent with various embodiments of the present disclosure. As shown in FIG. 14, hardware components of the computer device 1400 include a processor 1401 and a memory 1402. The memory 1402 stores computer programs executable by the processor 1401. When executing the computer programs, the processor 1401 performs the steps of the methods described in any of the above embodiments.

The memory 1402 stores computer programs executable by the processor 1401. The memory 1402 is configured to store instructions and applications executable by the processor 1401 and may further cache data to be processed or already processed by the processor 1401 and/or various modules of the computer device 1400 (e.g., image data, audio data, voice communication data, and video communication data). The memory 1402 may be implemented using flash memory, random access memory (RAM), or the like.

The steps of the methods described above may be implemented when the processor 1401 executes a computer program. The processor 1401 typically controls overall operation of the computer device 1400.

The present disclosure provides a computer-readable storage medium storing one or more programs that, when executed by one or more processors, cause performance of some or all of the steps of the methods described in any of the above embodiments.

It should be noted that the above storage medium and device embodiments correspond to the method embodiments and may provide similar beneficial effects. For technical details not expressly described in the storage medium and device embodiments, reference may be made to the corresponding descriptions of the method embodiments.

The processor may include one or more of the following: an application-specific integrated circuit (ASIC), a digital signal processor (DSP), a digital signal processing device (DSPD), a programmable logic device (PLD), a field-programmable gate array (FPGA), a central processing unit (CPU), a controller, a microcontroller, or a microprocessor. It will be understood that the processor may alternatively or additionally be implemented using other electronic components or devices capable of performing functions described herein, and the present disclosure is not limited to the above embodiments.

The computer-readable storage medium and/or memory may be read-only memory (ROM), programmable read-only memory (PROM), erasable programmable read-only memory (EPROM), electrically erasable programmable read-only memory (EEPROM), ferromagnetic random access memory (FRAM), flash memory, magnetic surface memory, an optical disc, a compact disc read-only memory (CD-ROM), or other types of memory. The computer-readable storage medium and/or memory may also be various devices such as mobile phones, computers, tablet devices, personal digital assistants (PDAs), or the like.

The phrases “one embodiment” or “an embodiment” as used throughout the present specification mean that a particular feature, structure, or characteristic described in connection with an embodiment is included in at least one embodiment of the present disclosure. Therefore, the phrases “in one embodiment” or “in an embodiment” appearing in various places throughout the specification do not necessarily all refer to the same embodiment. Furthermore, particular features, structures, or characteristics may be combined in any suitable manner in one or more embodiments. In the various embodiments, numbering of the above steps/processes does not imply any specific order of execution. An execution order of the steps/processes should be determined by function and inherent logic thereof and should not constitute any limitation on implementation processes of the embodiments of the present disclosure. The numbering of the embodiments in the present disclosure is for descriptive purposes only and does not represent superiority or inferiority of the embodiments.

In the present specification, terms “comprising”, “including”, and variations thereof are intended to denote non-exclusive inclusion, so that a process, method, article, or device that includes a list of elements includes not only the elements, but also other elements not expressly listed or elements inherent to such a process, method, article, or device. Unless otherwise specified, an element defined by the phrase “comprising a …” does not exclude the presence of additional identical elements in the process, method, article, or device.

In the embodiments of the present disclosure, the disclosed devices and methods may be implemented in other ways. The device embodiments described above are illustrative only. For example, division of units is a logical functional division, and other division approaches may be used in an actual implementation. For instance, a plurality of units or components may be combined or integrated into another system, and certain features may be omitted or not implemented. Furthermore, coupling, direct coupling, and/or communication connections between components shown or described herein may be implemented via one or more interfaces, and indirect coupling or communication connections between devices or units may be electrical, mechanical, or in other forms.

The units described above as separate components may or may not be physically separate, and components described as units may or may not correspond to physical units. The units may be located at a single location or distributed across a plurality of network nodes. Some or all of the units may be selected and/or configured according to implementation requirements to achieve the objectives of the embodiments described herein.

Furthermore, functional units in various embodiments may be fully integrated into a single processing unit, implemented as separate units, or implemented as two or more units integrated into a single unit. The integrated units may be implemented in hardware or in a combination of hardware and software functional units. Those skilled in the art will appreciate that all or part of the steps of the method embodiments described above may be implemented by hardware executing program instructions. The program instructions may be stored on a computer-readable storage medium and, when executed, cause performance of steps including those described in the method embodiments above. Example storage media include various media capable of storing program code, such as a mobile storage device, read-only memory (ROM), a magnetic disk, an optical disc, or the like.

Alternatively, when the integrated units described herein are implemented as software functional modules and sold or used as independent products, the software functional modules may be stored on a computer-readable storage medium. Accordingly, the technical solutions disclosed herein, or portions thereof contributing to the relevant technology, may be embodied as a software product. The software product may be stored on a storage medium and may include instructions that, when executed by a computer device (e.g., a personal computer, a server, a network device, or the like), cause the computer device to perform all or part of the methods described in the embodiments of the present disclosure. Example storage media include mobile storage devices, read-only memory (ROM), magnetic disks, optical discs, and other media capable of storing program code.

As disclosed, the token generation method and device provided by the present disclosure at least realizes the following beneficial effects.

The token generation method provides a decoding mechanism that supports inference acceleration while maintaining inference accuracy. In the present disclosure, tokens generated during an inference process are classified into correct (acceptable) tokens and incorrect (unacceptable) tokens. For correct tokens, decoding is performed using a weighted random sampling algorithm consistent with an original inference method, thereby maintaining an identical or substantially identical sequence of random numbers. For incorrect tokens, decoding is performed using a greedy selection algorithm (e.g., selecting a token having a highest probability), thereby avoiding generation or consumption of random numbers when decoding incorrect tokens and reducing or preventing perturbation of the sequence of random numbers used for decoding correct tokens. By preventing disruption of the sequence of random numbers associated with correct-token generation, the present disclosure can maintain outputs identical to, or highly consistent with, the original inference method while using lookahead or other acceleration strategies, thereby improving inference accuracy during accelerated decoding and enhancing user experience.

The above description is provided to illustrate embodiments of the present disclosure and is not intended to limit the present disclosure. Any modifications, variations, or substitutions that would be readily apparent to those skilled in the art in view of the present disclosure are intended to fall within the scope of the present disclosure.

What is claimed is:

1. A token generation method, comprising:
obtaining input information for a current inference stage of a target model, the input information including first tokens and second tokens, the first tokens including target tokens output from a previous inference stage, and the second tokens including guessing tokens output from the previous inference stage;
generating, based on inference performed by the target model, candidate weights for the first tokens and the second tokens, the candidate weights indicating likelihoods that candidate tokens are to be selected as target tokens; and
decoding the candidate weights for the first tokens using a first decoding algorithm to generate first target tokens and decoding the candidate weights for the second tokens using a second decoding algorithm to generate second target tokens, and the first decoding algorithm being different from the second decoding algorithm.

2. The method according to claim 1, wherein decoding the candidate weights for the first tokens using the first decoding algorithm to generate the first target tokens, and decoding the candidate weights for the second tokens using the second decoding algorithm to generate the second target tokens includes:
outputting, using the first decoding algorithm, a candidate token having a maximum candidate weight among the candidate weights for a first token with a first probability as a first target token;
outputting, using the second decoding algorithm, a candidate token having a maximum candidate weight among the candidate weights for a second token with a second probability as a second target token; and
the first probability being less than or equal to the second probability.

3. The method according to claim 2, wherein:
the candidate weights for the first token include a first probability distribution of first candidate tokens obtained by performing inference by the target model on the first token;
the candidate weights for the second token include a second probability distribution of second candidate tokens obtained by performing inference by the target model on the second token;
the outputting, using the first decoding algorithm, a candidate token with a maximum candidate weight among the candidate weights for a first token with the first probability as a first target token includes at least one of:
obtaining, from the first probability distribution, at least one candidate token having the maximum candidate weight using the first decoding algorithm; and randomly sampling from the at least one candidate token having the maximum candidate weight to generate the first target token; or
accumulating, probabilities starting from a first token of the candidate tokens in the first probability distribution, and randomly sampling from at least one accumulated first candidate token to generate the first target token when the accumulated value exceeds a preset random value, and the preset random value being a positive number greater than 0 and less than 1; and
the outputting, using the second decoding algorithm, the candidate token having a maximum candidate weight among the candidate weights for the second token with the second probability as the second target token including determining, a second candidate token having a highest probability in the second probability distribution, as a second target token.

4. The method according to claim 1, wherein the first tokens represent acceptable tokens output from a previous inference stage, and the second tokens represent guessing tokens output from the previous inference stage, the method further comprising:
identifying, from the guessing tokens, second acceptable tokens and first unacceptable tokens; and
decoding the second acceptable tokens using the first decoding algorithm and decoding the first unacceptable tokens using the second decoding algorithm.

5. The method according to claim 4, wherein the identifying, from the guessing tokens, the second acceptable tokens and the first unacceptable tokens includes:
decoding the first tokens using the first decoding algorithm to generate first acceptable tokens for a current inference stage;
determining, based on the first acceptable tokens, the second acceptable tokens and the first unacceptable tokens from the second tokens; and
generating, based on the first acceptable tokens and the second acceptable tokens, first tokens and second tokens in input information for a next inference stage.

6. The method according to claim 5, wherein the determining, based on the first acceptable tokens, the second acceptable tokens and the first unacceptable tokens from the second tokens includes at least one of:
determining a second token as a first unacceptable token when first guessing tokens for the second token are different from a first acceptable token; or
when the first guessing tokens for the second token are the same as the first acceptable token:
determining the first guessing tokens as first acceptable tokens to be inferred;
decoding the first acceptable tokens to be inferred using the first decoding algorithm to generate the second acceptable tokens;
repeatedly comparing the second acceptable tokens with a next guessing token for the second token after the first acceptable tokens to be inferred, determining the target guessing tokens as the first acceptable tokens to be inferred when the target guessing tokens are the same as the second acceptable token, and determining the target guessing tokens and the guessing tokens in the second tokens after the target guessing tokens as the first unacceptable tokens when the target guessing tokens are different from the second acceptable token.

7. The method according to claim 4, further comprising:
outputting the first acceptable tokens as target data when the first acceptable tokens satisfy a preset requirement; and
outputting the first acceptable tokens and the second acceptable tokens as the target data in a token generation order when the second acceptable tokens satisfy the preset requirement.

8. The method according to claim 1, further comprising:
obtaining at least one third token in a user input from a first inference stage of the target model;
decoding the at least one third token using the first decoding algorithm to generate third acceptable tokens output from the first inference stage;
generating, based on the at least one third token and the third acceptable tokens, fourth tokens including next guessing tokens after the third acceptable tokens; and
providing the at least one third token, the third acceptable tokens, and the fourth tokens as input information for a second inference stage.

9. The method according to claim 8, further comprising:
outputting the at least one third token and the third acceptable token as target data when the third acceptable tokens satisfy a preset requirement.

10. A computer device comprising one or more processors and a memory containing computer programs that, when being executed, cause the one or more processors to perform:
obtaining input information for a current inference stage of a target model, the input information including first tokens and second tokens, the first tokens including target tokens output from a previous inference stage, and the second tokens including guessing tokens output from the previous inference stage;
generating, based on inference performed by the target model, candidate weights for the first tokens and the second tokens, the candidate weights indicating likelihoods that candidate tokens are to be selected as target tokens; and
decoding the candidate weights for the first tokens using a first decoding algorithm to generate first target tokens and decoding the candidate weights for the second tokens using a second decoding algorithm to generate second target tokens, and the first decoding algorithm being different from the second decoding algorithm.

11. The device according to claim 10, wherein the one or more processors are further configured to perform:
outputting, using the first decoding algorithm, a candidate token having a maximum candidate weight among the candidate weights for a first token with a first probability as a first target token;
outputting, using the second decoding algorithm, a candidate token having a maximum candidate weight among the candidate weights for a second token with a second probability as a second target token; and
the first probability being less than or equal to the second probability.

12. The method according to claim 11, wherein:
the candidate weights for the first token include a first probability distribution of first candidate tokens obtained by performing inference by the target model on the first token;
the candidate weights for the second token include a second probability distribution of second candidate tokens obtained by performing inference by the target model on the second token, wherein
the one or more processors are further configured to perform at least one of:
obtaining, from the first probability distribution, at least one candidate token having the maximum candidate weight using the first decoding algorithm; and randomly sampling from the at least one candidate token having the maximum candidate weight to generate the first target token; or
accumulating, probabilities starting from a first token of the candidate tokens in the first probability distribution, and randomly sampling from at least one accumulated first candidate token to generate the first target token when the accumulated value exceeds a preset random value, and the preset random value being a positive number greater than 0 and less than 1; and
the one or more processors are further configured to perform:
determining, a second candidate token having a highest probability in the second probability distribution, as a second target token.

13. The device according to claim 10, wherein the first tokens represent acceptable tokens output from a previous inference stage, and the second tokens represent guessing tokens output from the previous inference stage, wherein the one or more processors are further configured to perform:
identifying, from the guessing tokens, second acceptable tokens and first unacceptable tokens; and
decoding the second acceptable tokens using the first decoding algorithm and decoding the first unacceptable tokens using the second decoding algorithm.

14. The device according to claim 13, wherein he one or more processors are further configured to perform:
decoding the first tokens using the first decoding algorithm to generate first acceptable tokens for a current inference stage;
determining, based on the first acceptable tokens, the second acceptable tokens and the first unacceptable tokens from the second tokens; and
generating, based on the first acceptable tokens and the second acceptable tokens, first tokens and second tokens in input information for a next inference stage.

15. The device according to claim 14, wherein the one or more processors are further configured to perform at least one of:
determining a second token as a first unacceptable token when first guessing tokens for the second token are different from a first acceptable token; or
when the first guessing tokens for the second token are the same as the first acceptable token:
determining the first guessing tokens as first acceptable tokens to be inferred;
decoding the first acceptable tokens to be inferred using the first decoding algorithm to generate the second acceptable tokens;
repeatedly comparing the second acceptable tokens with a next guessing token for the second token after the first acceptable tokens to be inferred, determining the target guessing tokens as the first acceptable tokens to be inferred when the target guessing tokens are the same as the second acceptable token, and determining the target guessing tokens and the guessing tokens in the second tokens after the target guessing tokens as the first unacceptable tokens when the target guessing tokens are different from the second acceptable token.

16. The device according to claim 13, wherein the one or more processors are further configured to perform:
outputting the first acceptable tokens as target data when the first acceptable tokens satisfy a preset requirement; and
outputting the first acceptable tokens and the second acceptable tokens as the target data in a token generation order when the second acceptable tokens satisfy the preset requirement.

17. The device according to claim 10, wherein the one or more processors are further configured to perform:
obtaining at least one third token in a user input from a first inference stage of the target model;
decoding the at least one third token using the first decoding algorithm to generate third acceptable tokens output from the first inference stage;
generating, based on the at least one third token and the third acceptable tokens, fourth tokens including next guessing tokens after the third acceptable tokens; and
providing the at least one third token, the third acceptable tokens, and the fourth tokens as input information for a second inference stage.

18. The device according to claim 17, wherein the one or more processors are further configured to perform:
outputting the at least one third token and the third acceptable token as target data when the third acceptable tokens satisfy a preset requirement.

19. A non-transitory computer readable storage medium containing computer programs that, when being executed, cause at least one processor to perform:
obtaining input information for a current inference stage of a target model, the input information including first tokens and second tokens, the first tokens including target tokens output from a previous inference stage, and the second tokens including guessing tokens output from the previous inference stage;
generating, based on inference performed by the target model, candidate weights for the first tokens and the second tokens, the candidate weights indicating likelihoods that candidate tokens are to be selected as target tokens; and
decoding the candidate weights for the first tokens using a first decoding algorithm to generate first target tokens and decoding the candidate weights for the second tokens using a second decoding algorithm to generate second target tokens, and the first decoding algorithm being different from the second decoding algorithm.

20. The storage medium according to claim 19, wherein the at least one processor is further configured to perform:
outputting, using the first decoding algorithm, a candidate token having a maximum candidate weight among the candidate weights for a first token with a first probability as a first target token;
outputting, using the second decoding algorithm, a candidate token having a maximum candidate weight among the candidate weights for a second token with a second probability as a second target token; and
the first probability being less than or equal to the second probability.
